(19) United States
(12) Patent Application Publication
(10) Pub. No.: US 2017/0044379 A1
(43) Pub. Date: Feb. 16, 2017

(54) SELF-HEALING COATING FOR REINFORCEMENT STEEL

(71) Applicant: Worcester Polytechnic Institute, Worcester, MA (US)

(72) Inventors: Amy M. Peterson, Cambridge, MA (US); Aaron R. Sakulich, Worcester, MA (US); Yixi Chen, Liaoning (CN); Chris T. Xia, Malden, MA (US)

(21) Appl. No.: 15/233,029

(22) Filed: Aug. 10, 2016

Related U.S. Application Data
(60) Provisional application No. 62/204,006, filed on Aug. 12, 2015.

(51) Int. Cl. C09D 5/08; E04C 5/01; C09D 7/12

(52) U.S. Cl. CPC C09D 5/086; C09D 7/1258; E04C 5/015

(57) ABSTRACT

A self-healing coating for reinforcing steel embedded in concrete includes emulsion derived microcapsules having a healing agent and adapted for dispersion through a liquid coating medium for application on a structural steel surface to form a coating for corrosion prevention. The microcapsule particles are dispersed in the coating medium for being disposed on the surface and are configured to rupture and release the healing agent onto the surface in response to a compromise of the coating, such as being dropped or dragged on a construction site. The self-healing agent, such as Tung oil, complements the protective properties of the coating medium by flowing into regions where the coating medium has been scraped off, flaked off, or otherwise undergone compromise. Alternatively, post-installation corrosive influences, such as rust and oxidation, can also cause rupture of the particles to abate corrosion in the concrete-encased steel members.

### RELATED APPLICATIONS

This application claims the benefit under 35 U.S.C. §119(e) of U.S. Provisional Patent Application No. 62/204,006, filed Aug. 12, 2015, entitled “SELF HEALING STEEL COATING” incorporated herein by reference in entirety.

### BACKGROUND

Steel reinforced concrete is commonly employed in civil engineering contexts, in particular with infrastructure developments such as bridges, roads and tunnels, but also in commercial construction. Ribbed steel rods, or rebar (reinforcement bar), is typically inserted into a concrete form, and concrete molded (poured) around the inserted rebar forming an encapsulated steel which complements the compressive strength of the concrete. Premature failure of reinforced concrete has often been associated with corrosion and oxidation of the embedded steel members.

In particular, steel-reinforced concrete is by far the most widely used infrastructure material, with approximately 7 billion cubic meters currently in place in the U.S. alone. An additional 380 million cubic meters are added each year. Electrochemical corrosion, which occurs when aggressive media break down the protective oxide film on reinforcing steel and enable the production of rust, is one of the most significant contributors to service life reduction in steel-reinforced concrete

### SUMMARY

A self-healing coating for reinforcing steel embedded in concrete includes emulsion derived microcapsules having a healing agent disposed in particles adapted for dispersion through a liquid, and a coating medium adapted to be disposed on a structural steel surface to form a coating for corrosion prevention. The particles (microcapsules) are dispersed in the liquid coating medium for being applied to the surface and are configured to rupture and release the healing agent onto the surface in response to a compromise of the coating, such as being dropped or dragged on a construction site. The self-healing agent, such as Tung oil, complements the protective properties of the coating medium by flowing into regions where the coating medium has been scraped off, flaked off, or otherwise undergone compromise. Alternatively, post-installation corrosive influences, such as rust and oxidation, can also cause rupture of the particles to abate corrosion in the concrete-encased steel members. Configurations herein are based, in part, on the observation that steel-reinforced concrete remains a substantial structural component for many infrastructure and commercial construction needs. The symbiotic combination of the tensile strength of steel coupled with the compressive strength of concrete provides a versatile load bearing construction medium. Unfortunately, reinforcing steel encased in the concrete, typically ribbed steel rods known as rebar, suffers from corrosion and oxidation within the concrete. Rebar is typically coated with a rust preventative, but the rough environment of construction sites coupled with course aggregate (rocks) in the concrete poured over the rebar during installation can often scratch and compromise the rebar, leaving exposed regions susceptible to corrosive elements. Accordingly, configurations herein substantially overcome the above described shortcomings of conventional rust preventative coatings and epoxies by providing a self-healing coating having microcapsules filled with a healing agent dispersed as particles throughout the self-healing coating. The microcapsules have a polymer coating responsive to physical abrasion by rupturing and distributing the healing agent around the damaged region. Following encapsulation in concrete, the microcapsule particles remain on the coating and are responsive to oxidation and corrosion by rupturing and releasing the healing agent across the oxidation region for retarding corrosion.

In an example configuration, the healing agent is Tung oil, and the self-healing coating is a liquid epoxy medium similar to conventional rust preventative coatings. Upon construction site handling, typically by being dropped or dragged in conjunction with hard surfaces, scratched or abraded epoxy regions release the healing agent from the microcapsules (particles) ruptured by the damage. Scratched epoxy regions therefore result in the healing agent filling in the scratch to compensate for the breached coating. However, any suitable healing agent may be encapsulated in the particles and other liquid mediums in addition to epoxy may be employed for coating the structural steel.

In further detail, the method for disposing a self-healing coating on reinforcing steel rebar as disclosed herein includes preparing a microcapsule emulsion for generating particles containing a healing agent surrounded by a polymer shell, and combining the particles with a liquid coating for preventing oxidation of steel members.

Either prior to or during formation concrete molds, a spray or brush process applies the coating with the particles to a structural reinforcing member (rebar). The construction process often involves introducing the coated, structural reinforcing member into a compromising environment, such that the compromising environment causes the shell to rupture and release the healing agent. The healing agent complements the corrosion prevention of the coating by flowing into and covering gaps in a compromised region of the liquid coating upon release from a ruptured shell.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of a construction environment suitable for use with configurations disclosed herein;

FIG. 2 is a side cutaway view of a structural member with the self-healing coating applied;

FIGS. 3a and 3b show ruptured microcapsules performing self-healing on the structural member of FIG. 2;

FIG. 4 shows a top section of the healing agent flowing from microcapsules onto a compromised region; and

FIG. 5 shows a distribution of the microcapsule diameter of the particles dispersed through the coating of FIGS. 2-4.

### DETAILED DESCRIPTION

The figures and examples below depict an anticorrosion coating for structural steel members such as rebar that employs microcapsules containing a healing agent for releasing the healing agent in response to abrasion, damage or pH changes indicative of corrosive infiltration in reinforced concrete. The anti-corrosion coating, such as a polymer or resin based mixture, distributes poly(urea-formaldehyde) microcapsules of Tung oil or other healing agent along the surface of the rebar. The microcapsules of Tung oil define a secondary phase healing agent releasable in response to detected damage or corrosion for protecting the steel surface from corrosive infiltration from water, road salt and other foreign elements that permeate the concrete and cause degradation of the reinforcing steel.

The most common method of preventing steel corrosion in reinforced concrete is the use of epoxy-coated rebar (ECR). The epoxy thermoset acts as a physical barrier that can prevent, or significantly delay, the onset of corrosion. Other methods of corrosion prevention are either significantly more expensive (e.g. using stainless steel rebar) or significantly more difficult to use in the field (e.g. galvanic protection). However, ECR is only effective if the brittle epoxy coating is kept in excellent condition. Chips or cracks in the epoxy provide aggressive media access to the reinforcing steel and negate the protective properties of the system. Although improvements in the manufacture of ECR have reduced the number of imperfections, flaws are still routinely encountered. This project reports the first use of self-healing coatings for rebar in steel-reinforced concrete. When damage occurs in self-healing coatings, microcapsules rupture and healing agent passivates the surface and restores the physical barrier to corrosive species. Based on preliminary results, the self-healing coatings may extend infrastructure lifetimes threefold. Since the disclosed coatings are applied similarly to conventional epoxy coatings, usage is less expensive than stainless steel rebar, which is preferentially used over ECR for its improve corrosion resistance.

Conventional approaches suffer from the shortcoming of phase change, allowing only a one-time healing action, or a vascular approach, which includes a fluidic network. One-time healing approaches impose that once the healing agent has reacted and gone from a monomer (liquid) to a polymer (solid), there can be no more healing in that location. Vascular approaches are a strategy for compensating for the lack of a healing agent in secondary phase-based approaches, by including a network through which healing agent can flow. However, this is not feasible in a coating. Secondary phase approaches employ a coating material to which a second phase is added, such as fluid contained capsules, however sometimes there can be natural phase separation of the healing agent from the coating matrix, rendering a capsule unnecessary.

Depicted below is a particular configuration of the self-healing coating for reinforcing steel embedded in concrete, such as rebar. FIG. 1 is a context diagram of a construction environment suitable for use with configurations disclosed herein.

Referring to FIG. 1, in a construction environment 100, a particular configuration applies the self-healing coating to structural steel members such as rebar (reinforcement bar) 110, which is typically stacked or piled near a mold or form 120 for concrete. Stacking or piling the rebar 110 causes individual bars 110′ to impact and frictionally engage other rebar 110, scraping or scratching the exterior surface and any applied coating. The stacked rebar 110 is eventually disposed in the form 120, such as by a crane cable 112, where it is bound, welded or otherwise attached to other rebar 110 members. The form 120 is filled with concrete 122, typically by a chute 124 or pump hose. Typical concrete has various sizes of aggregate 126, which are simply rocks or other solid mass, which can impact the rebar 110 as the concrete 122 falls into the mold.

In sum, structural steel members such as rebar encounter many manipulations which can cause physical damage or discontinuities in the rebar coating. In conventional approaches, the discontinuities represent paths for corrosion and degradation. In contrast, in configurations described below, physical agitation of the coating ruptures the microcapsules and releases the healing agent.

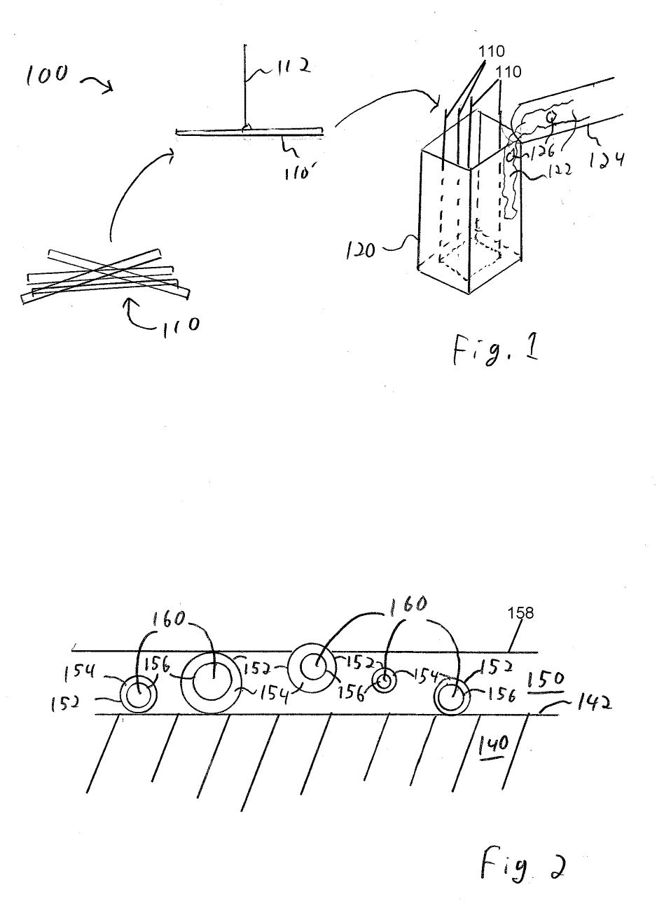

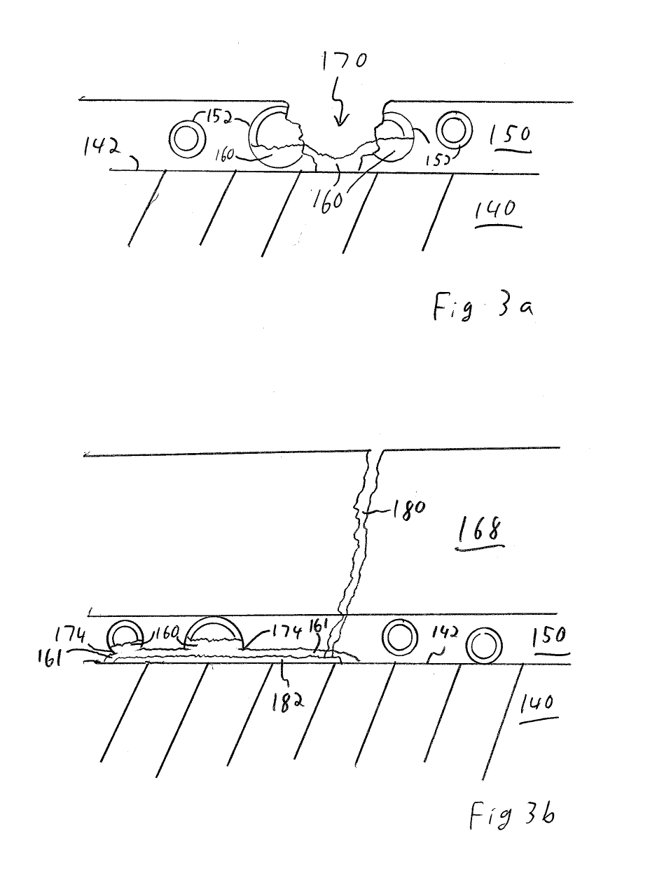

FIG. 2 is a side cutaway view of a structural member with the self-healing coating applied. Referring to FIGS. 1 and 2, a structural steel member 140 such as rebar is coated with the self-healing coating 150. The coating 150 is expected to be a liquid medium such as epoxy or other rugged substance that provides substantial corrosion protections while intact. In contrast to conventional approaches, microcapsules 152 are distributed throughout the coating 150. The ratio of particles dispersed in the liquid medium is 10-20% of the coating. The microcapsules 152 have a polymer shell 154 surrounding a cavity 156 for containing a quantity of the healing agent 160, such as Tung oil. In an example configuration, a thickness of the applied coating is in a range between 0.02 and 0.19 mm, and the size of the microcapsule particles is in a range from 0.20 mm-0.65 mm and an average particle size of substantially around 0.3 mm. Accordingly, a substantial quantity of the microcapsules may be in contact with the rebar surface 142, and others may meet the outer surface 158 of the coating. Dispersion of the microcapsules 152 (particles) through the coating 150 ensures a robust response of healing agent 160 upon physical compromise of the coating 150.

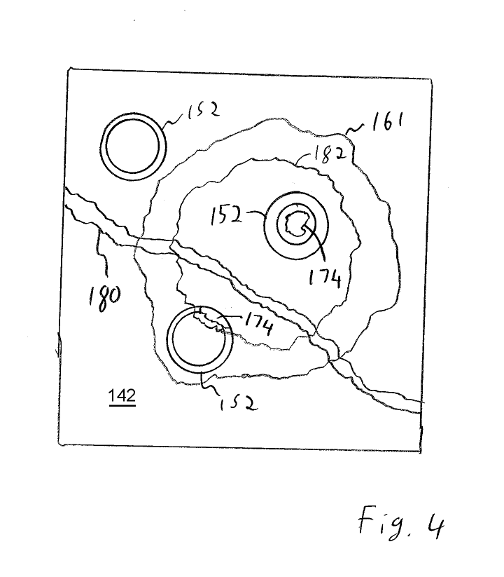

FIGS. 3a and 3b show ruptured microcapsules performing self-healing on the structural member of FIG. 2. Particle rupture may result from physical compromise of the applied coating surface prior to or during concrete casting including the coated reinforcing members, as in FIG. 3a, or may result from oxidation of concrete-encased steel onto which the coating has been applied, as in FIG. 3b. Referring to FIGS. 2 and 3a, a scratch or impact creates a void 170 or rupture in the self-healing coating 158. As a result, some of the microcapsules 152 are breached, and allow the healing agent 160 (Tung oil) to flow into the void 170 and cover the rebar surface 142. Drying oils such as Tung oil and linseed oil have been noted regarding their healing properties and encapsulation. Upon exposure to air, Tung oil will polymerize into a tough, glossy, waterproof coating, effectively compensating for the loss of protection from the damaged area and providing the healing effect. These characteristics have made drying oils a valuable component in paints, varnishes, and printing inks. Alternative healing agents may be encapsulated based on healing properties.

Referring to FIGS. 2 and 3b, in another scenario, corrosion from elemental factors, such as rain, road salt and other factors, may infiltrate the concrete 168 through a crack 180. Due to the porous nature of the concrete, corrosive influences may still enter even unbreached concrete 168. Corrosion 182 on the surface of the rebar 140 causes a breach 174 in the polymer shell 154, which distributes the healing agent 160 in a protective flow 161 over the compromised region along the rebar surface 142. Further, pH changes resulting from the corrosive influences may also facilitate rupture of the microcapsules 152.

FIG. 4 shows a top section view of the healing agent 160 flowing from microcapsules 152 onto a compromised region. Referring to FIGS. 2 and 4, corrosion 182 caused by the crack 180 or other factors results in the compromised region, is then covered by the healing agent 160 flowing from the breach 174 in the microcapsules 152 to form the protective flow 161. In implementation, reinforced concrete having rebar with the applied self-healing coating has an extended service live of up to 300% over reinforced concreate without coated rebar.

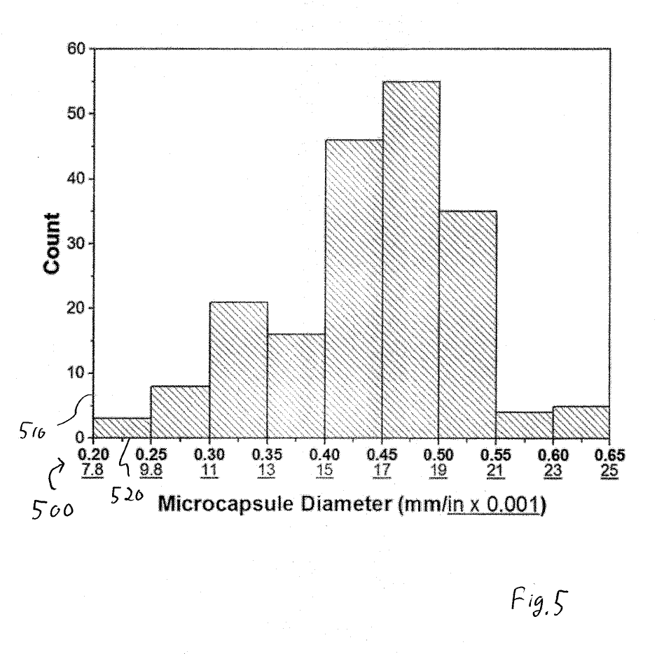

FIG. 5 shows a distribution 500 of the microcapsule diameter of the particles dispersed through the coating of FIGS. 2-4. Formation of the microcapsules 152 as detailed further below results in a quantity of microcapsules 152 distributed according to a count 510 for a subrange of sizes 520. Referring to FIGS. 2 and 5, the microcapsules 152 are defined by particles that range in size from 0.20 mm-0.65 mm in diameter. Various changes to the size of the microcapsules 152, as well as a thickness of the polymer shell 154 surrounding and defining the cavity 156 holding the healing agent 160, may be achieved in alternate configurations.

The healing agent encapsulated in the microcapsules may be any suitable substance that promotes passivity, longevity and/or mitigates corrosion or compromise of the structural steel member. In the example configuration, Tung oil has shown to be an effective healing agent, and the Tung oil microcapsules are generated as described below. The microcapsules are formed from an emulsion, generally regarded as a mixture of two or more liquids that are normally immiscible. The formed microcapsules are particles, nanoparticles or other particles dispersed throughout a liquid medium for application as a coating on reinforcing members embedded in concrete prior to curing.

The procedure used for encapsulating Tung oil was begins with an oil-in-water emulsion to which the following components were added: ethyl maleic anhydride (EMA) solution as a surfactant, resorcinol to stabilize the solution, ammonium chloride to provide a pH buffer, and urea reacting with formaldehyde to form the polymer shells. At room temperature, 200 mL of deionized water, 25 mL of 2.5 wt. % EMA solution, 0.5 g of resorcinol, 0.5 g of ammonium chloride, and 5 g of urea were mixed fully in a 500 mL beaker. Following this, the pH of the solution was adjusted from 2.7 to 3.5 using a dilute sodium hydroxide solution in order to control the morphology of the polymer shells. This solution was placed into a room temperature water bath and stirred at 400 rpm as 50 mL of Tung oil was slowly added into the solution. The resulting mixture was mechanically stirred at 400 rpm for 10 minutes to form a stabilized emulsion, after which 13 g of 37 wt. % formaldehyde solution was added. The temperature of the solution was raised to 60° C. for 4 hours at 400 rpm to facilitate the polymerization reaction between urea and formaldehyde. The solution was then removed from the oil bath and stirred as it cooled to room temperature over 6 hours.

To extract the microcapsules, the mixture was vacuum filtered with coarse filter paper, then washed with deionized water and acetone, respectively. Finally, the microcapsules were air-dried for 48 hours before they could be used. Both poly[(phenyl isocyanate)-co-formaldehyde] (isocyanate pre-polymer, number of reactive groups per molecule˜3.0, MW˜375) and poly(vinyl alcohol) (PVA, MW-9,000-10,000, 80% hydrolyzed) were obtained. 2-methylbenzothiazole, ethylenediamine, and tetraethylenepentamine (TEPA) were procured from various sources. All chemicals were used without any purification.

Encapsulation of Tung oil is achievable using the same approach as that used for Encapsulation of 2-methylbenzothiazole, as follows. At room temperature, 40 mL of deionized water, 5 mL of 2.5 wt.% EMA solution, 0.1 g of resorcinol, 0.1 g of ammonium chloride, and 1 g of urea were mixed fully in a 500 mL beaker. Once the solids were completely dissolved, the solution was adjusted to a pH of 3.5 using dilute sodium hydroxide. This was placed into a room temperature water bath and stirred at 400 rpm as 5 mL of 2-methylbenzothiazole was slowly added to the solution. The resulting mixture was mechanically stirred at 400 rpm for 10 minutes to form a stabilized emulsion, after which 2.6 g of 37 wt. % formaldehyde solution was added. The temperature of the solution was raised to 60° C. for 4 hours at 400 rpm to facilitate a polymerization reaction. The resulting solution was filtered using vacuum filtration and rinsed with deionized water and acetone.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A self-healing coating for reinforcing steel embedded in concrete, comprising:
emulsion derived microcapsules having a healing agent disposed in particles adapted for dispersion through a liquid medium;
a coating defined by the liquid medium adapted to be disposed on a surface to form a coating for corrosion prevention;
the particles dispersed in the coating for being disposed on the surface and configured to rupture and release the healing agent onto the surface in response to a compromise of the coating.

2. The coating of claim 1 wherein the particle rupture results from physical compromise of the applied coating surface prior to or during concrete casting including the coated reinforcing members

3. The coating of claim 1 wherein the particle rupture results from oxidation of concrete-encased steel onto which the coating has been applied.

4. The coating of claim 1 wherein the ratio of particles dispersed in the liquid medium is 10-20% of the coating medium.

5. The coating of claim 4 wherein the healing agent is Tung oil.

6. The coating of claim 1 wherein the size of the particles is in a range from 0.20 mm-0.65 mm and an average particle size of substantially around 0.3 mm.

7. The coating of claim 1 wherein a thickness of the applied coating is in a range between 0.02 and 0.19 mm.

8. The coating of claim 1 wherein reinforced concrete having rebar with the applied self healing coating has an extended service live of 300% over reinforced concreate without coated rebar.

9. A method for disposing a self-healing coating on reinforcing steel rebar, comprising:
preparing a microcapsule emulsion for generating particles containing a healing agent surrounded by a polymer shell;
combining the particles with a liquid medium including a coating for preventing oxidation of steel members;
applying the coating with the particles to a structural reinforcing member; and
introducing the coated, structural reinforcing member into a compromising environment, the compromising environment causing the particle shell to rupture and release the healing agent,
the healing agent complementing the corrosion prevention of the coating by flowing into and covering gaps in a compromised region of the coating upon release from a ruptured shell.

10. The method of claim 9 further comprising disposing the structural reinforcing member within a load bearing member having compressive strength, the structural reinforcing member providing tensile strength;

11. The method of claim 9 further comprising brushing the coating onto a steel structural member prior to embedding in concrete.

12. The method of claim 9 wherein the particle rupture results from physical compromise of the applied coating surface prior to or during concrete casting including the coated reinforcing members

13. The method of claim 9 wherein the particle rupture results from oxidation of concrete-encased steel onto which the coating has been applied.

14. The method of claim 9 wherein the ratio of particles dispersed in the liquid medium is in the range of 10-20%.

15. The method of claim 14 wherein the healing agent is Tung oil.

16. The method of claim 9 wherein a size of the particles is in a range from 0.20 mm-0.65 mm and an average particle size of substantially around 0.3 mm.

17. The method of claim 9 wherein a thickness of the applied coating is in a range between 0.02 and 0.19 mm.

18. The method of claim 9 wherein reinforced concrete having rebar with the applied self-healing coating has an extended service live of 300% over reinforced concreate without coated rebar.

19. A reinforcing steel member for concrete, comprising:
a coating including emulsion derived microcapsules having a healing agent disposed in particles;
the coating disposed on a surface of the structural steel member to form a barrier for corrosion prevention;
the particles dispersed in the coating and configured to rupture and release the healing agent onto the surface in response to a compromise of the coating.
